(19) United States
(12) Patent Application Publication
(10) Pub. No.: US 2023/0384256 A1
(43) Pub. Date: Nov. 30, 2023

(54) SENSOR ELEMENT AND GAS SENSOR

(71) Applicant: NGK INSULATORS, LTD., Nagoya (JP)

(72) Inventors: Michiaki ISODA, Nagoya (JP); Kei KOSAKA, Nagoya (JP); Yosuke NORITAKE, Vernon Hills, IL (US); Keita KAYANO, Nagoya (JP)

(21) Appl. No.: 18/359,847

(22) Filed: Jul. 26, 2023

Related U.S. Application Data
(63) Continuation of application No. PCT/JP2022/006509, filed on Feb. 18, 2022.

(30) Foreign Application Priority Data
Mar. 30, 2021 (JP) 2021-057628

(51) Int. Cl. G01N 27/407; G01N 27/409

(52) U.S. Cl. CPC G01N 27/4077; G01N 27/4075; G01N 27/4071; G01N 27/409

(57) ABSTRACT

A sensor element includes an element body, a detection unit, a connector electrode, a porous layer that covers at least the front end-side part of a side surface on which the connector electrode is disposed and that has a porosity of 10% or more, and a dense layer. The dense layer is disposed on the side surface so as to divide the porous layer in the longitudinal direction of the element body or to be located closer to the rear end than the porous layer. The dense layer is located closer to the front end of the sensor element than the connector electrode. The dense layer covers the side surface and has a porosity of less than 10%. The dense layer includes an overlap portion that is a front end portion of the dense layer and covers the outer surface of a part of the porous layer.

This application is a continuation application of PCT/JP2022/006509, filed on Feb. 18, 2022, which claims the benefit of priority of Japanese Patent Application No. 2021-057628 filed on Mar. 30, 2021, the entire contents of which are incorporated herein by reference.

### BACKGROUND OF THE INVENTION

### 1. Field of the Invention

The present invention relates to a sensor element and a gas sensor.

### 2. Description of the Related Art

Sensor elements that detect the concentration of a specific gas, such as NOx, in the measurement-object gas, such as an automotive exhaust gas, are known (e.g., PTL 1). The sensor element described in PTL 1 includes a long-length element body; an outer electrode, an outer lead portion, and connector electrodes that are disposed on the upper surface of the element body; and a porous layer that covers the outer electrode and the outer lead portion. The outer electrode, the outer lead portion, and the connector electrodes are connected to and in electrical conduction with one another in this order. The connector electrodes are electrically connected to the outside. The sensor element described in PTL 1 also includes a dense layer arranged to divide the porous layer in the longitudinal direction of the element body. The dense layer covers the outer lead portion. Since moisture is unlikely to pass through the dense layer, in the case where moisture included in the measurement-object gas moves inside the porous layer by capillarity, the presence of the dense layer reduces the likelihood of the moisture reaching the connector electrodes. This reduces the rusting and corrosion of the connector electrodes and the short circuit between the connector electrodes.

### CITATION LIST

### Patent Literature

PTL 1: WO 2019/155865 A1

### SUMMARY OF THE INVENTION

There has been a demand for a further reduction in the likelihood of the moisture reaching the connector electrodes of a sensor element including a dense layer as in PTL 1.

The present invention was made in order to address the above issues. An object of the present invention is to prevent the moisture from reaching the connector electrodes.

The present invention employs the following structures in order to achieve the primary object.

A sensor element according to the present invention is a sensor element including: a long-length element body including front and rear ends and one or more side surfaces, the front and rear ends being ends of the element body in a longitudinal direction of the element body, the one or more side surfaces being surfaces extending in the longitudinal direction; a detection unit including a plurality of electrodes disposed in the front end-side part of the element body, the detection unit detecting a specific gas concentration in a measurement-object gas; one or more connector electrodes disposed on the rear end-side part of any of the one or more side surfaces, the one or more connector electrodes used for electrical conduction with an outside; a porous layer that covers at least the front end-side part of the side surface on which the one or more connector electrodes are disposed, the porous layer having a porosity of 10% or more; and a dense layer disposed on the side surface so as to divide the porous layer in the longitudinal direction or to be located closer to the rear end than the porous layer, the dense layer being located closer to the front end than the one or more connector electrodes, the dense layer covering the side surface and having a porosity of less than 10%, wherein the dense layer includes an overlap portion that is a front end portion of the dense layer, the overlap portion covering an outer surface of a part of the porous layer.

In the above-described sensor element, the connector electrodes are disposed on a rear end-side part of any of the one or more side surfaces of the element body, and the porous layer is arranged to cover at least the front end-side part of the side surface. Furthermore, the sensor element includes the dense layer disposed on the side surface so as to divide the porous layer in the longitudinal direction or to be located closer to the rear end than the porous layer. The dense layer is located closer to the front end than the connector electrodes. Therefore, when the front end-part of the element body, in which a plurality of electrodes constituting the detection unit are present, is exposed to a measurement-object gas, even if the moisture contained in the measurement-object gas moves inside the porous layer toward the rear end of the element body by capillarity, the moisture reaches the dense layer before reaching the connector electrodes. Since the dense layer has a porosity of less than 10% and the capillarity of water through the dense layer is unlikely to occur, the likelihood of the moisture passing through the dense layer is small. Furthermore, the dense layer includes an overlap portion that is the front end portion of the dense layer and covers the outer surface of a part of the porous layer. This reduces the likelihood of water that has moved toward the rear end of the element body through the porous layer moving backward of the dense layer along the outer surface of the dense layer. Thus, in the sensor element, since water is unlikely to pass through the inside and outer surface of the dense layer, the likelihood of the moisture reaching the connector electrodes can be reduced.

In the sensor element according to the present invention, the length of the overlap portion in the longitudinal direction, that is, the overlap length Lov, may be 40 μm or more.

In the sensor element according to the present invention, the length of the overlap portion in the longitudinal direction, that is, the overlap length Lov, may be 10000 μm or less.

The sensor element according to the present invention may further include an outer lead portion disposed on the side surface on which the one or more connector electrodes are disposed, the outer lead portion providing conduction between any of the electrodes and the one or more connector electrodes. The porous layer and the dense layer may cover the outer lead portion. For reducing the likelihood of the moisture moving along the outer surface of the dense layer, for example, a gap region may be interposed between the porous layer and the dense layer, instead of forming the above-described overlap portion. However, if such a gap region is formed when the outer lead portion is present, the outer lead portion is disadvantageously exposed to the outside of the sensor element at the gap region. In contrast, interposing an overlap portion, instead of a gap region, between the porous layer and the dense layer protects the outer lead portion while reducing the likelihood of the moisture reaching the connector electrodes.

In the above case, the porous layer may cover the entirety of the part of the outer lead portion which is not covered with the dense layer. The sensor element according to the present invention may include an outer electrode that is one of the electrodes included in the detection unit, the outer electrode being in conduction with the connector electrodes via the outer lead portion and disposed on the side surface on which the connector electrodes are disposed. In such a case, the porous layer may cover the outer electrode.

The gas sensor according to the present invention includes the sensor element according to any one of the above-described aspects. Therefore, the gas sensor has the same advantageous effects as the above-described sensor element according to the present invention. That is, for example, the gas sensor is capable of reducing the likelihood of the moisture reaching the connector electrodes.

### BRIEF DESCRIPTION OF THE DRAWINGS

FIG. 1 is a longitudinal cross-sectional view of a gas sensor 10 attached to a pipe 58.

FIG. 2 is a perspective view of a sensor element 20.

FIG. 3 is a cross-sectional view taken along the line A-A of FIG. 2.

FIG. 4 is a top view of the sensor element 20.

FIG. 5 is a bottom view of the sensor element 20.

FIG. 6 is a top view illustrating the positions of cross sections A1 and A2 in which an overlap length Lov is observed.

FIG. 7 is a cross-sectional view illustrating the state of an overlap portion 92a of a first dense layer 92.

FIG. 8 is a cross-sectional view illustrating the state of a first dense layer 192 of Comparative Example.

FIG. 9 is a top view of a sensor element 20 according to a modification example.

FIG. 10 is a bottom view illustrating a second dense layer 95 and a second gap region 96 according to a modification example.

### DETAILED DESCRIPTION OF THE INVENTION

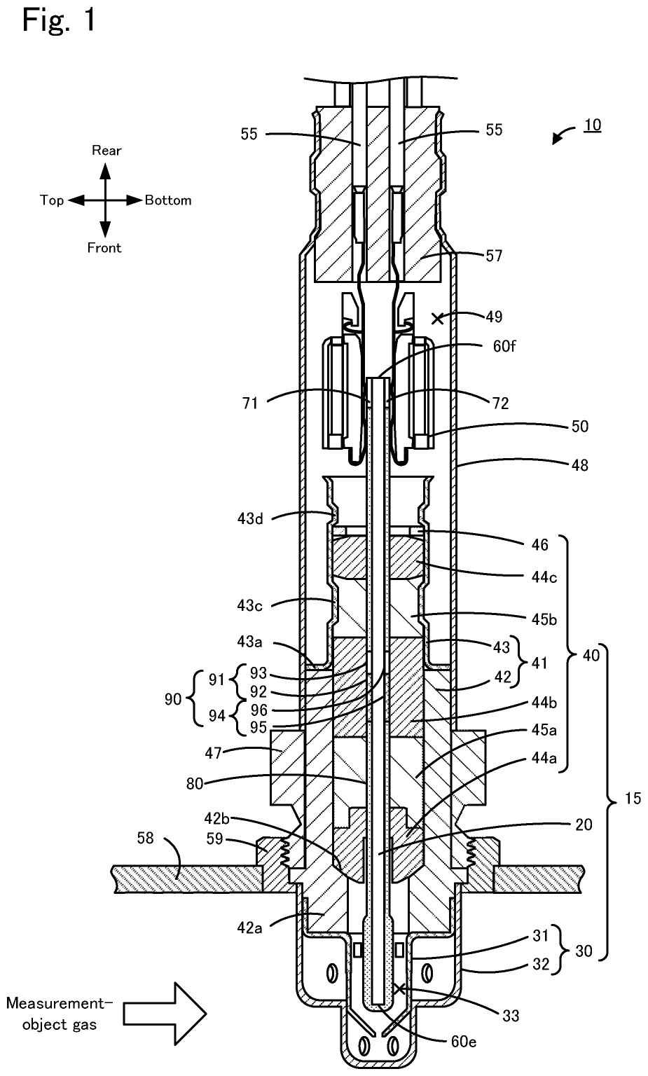

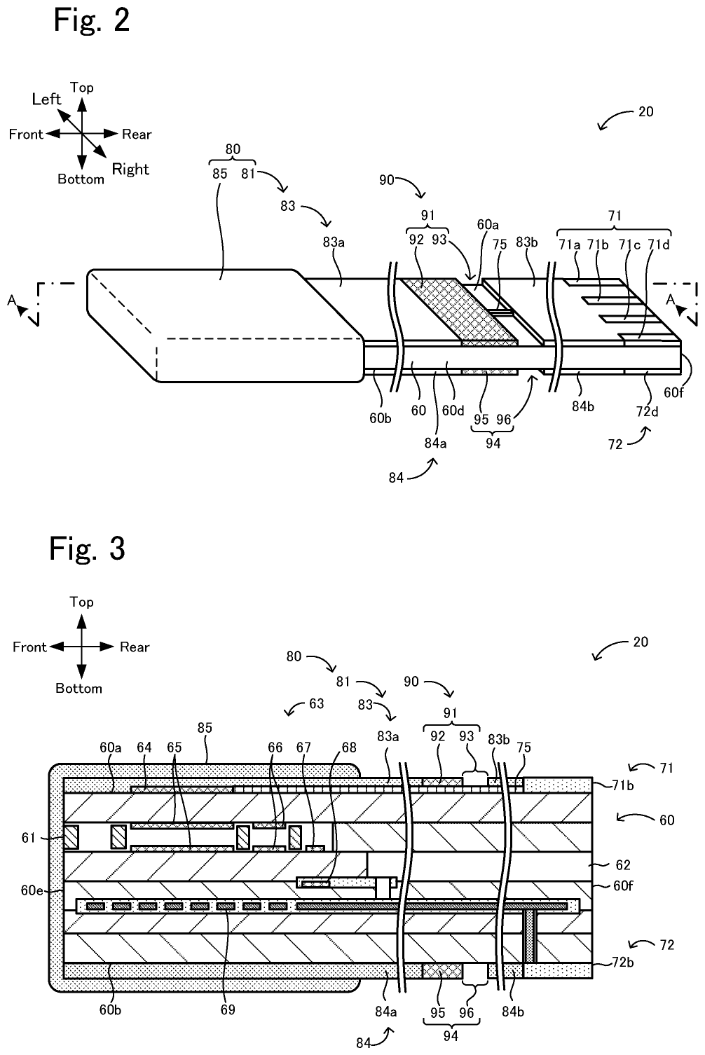

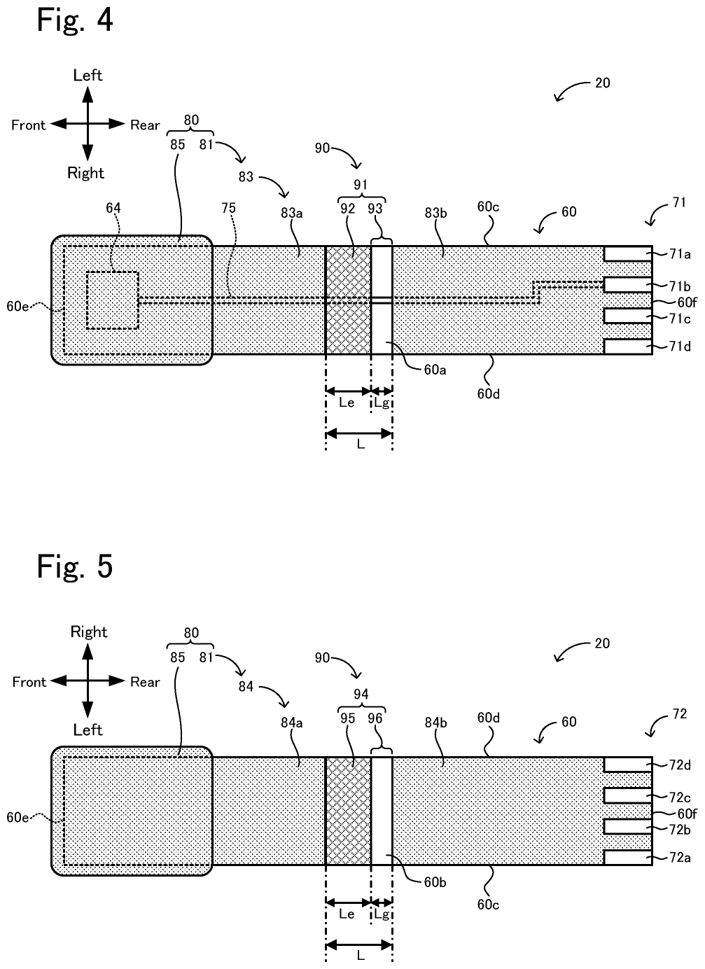

Embodiments of the present invention are described below with reference to the attached drawings. FIG. 1 is a longitudinal cross-sectional view of a gas sensor 10 according to an embodiment of the present invention which is attached to a pipe 58. FIG. 2 is a perspective view of a sensor element 20 viewed from the upper right front. FIG. 3 is a cross-sectional view taken along the line A-A in FIG. 2. FIG. 4 is a top view of the sensor element 20. FIG. 5 is a bottom view of the sensor element 20. In this embodiment, as illustrated in FIGS. 2 and 3, the longitudinal direction of the element main body 60 included in the sensor element is referred to as “front-to-rear direction” (length direction), the direction in which the layers constituting the element main body 60 are stacked (thickness direction) is referred to as “top-to-bottom direction”, and a direction perpendicular to the front-to-rear direction and the top-to-bottom direction is referred to as “left-to-right direction” (width direction).

As illustrated in FIG. 1, the gas sensor 10 includes an assembly 15, a bolt 47, an external cylinder 48, a connector 50, lead wires 55, and a rubber stopper 57. The assembly 15 includes a sensor element 20, a protective cover and an element-sealing member 40. The gas sensor 10 is attached to a pipe 58, such as an automotive exhaust gas pipe, and used for measuring the specific gas concentration, such as NOx or O₂, (particular gas concentration) in the exhaust gas, which is the gas to be analyzed. In this embodiment, the gas sensor 10 is a gas sensor that measures NOx concentration as a particular gas concentration. Among the ends (front and rear ends) of the sensor element 20 in the longitudinal direction, the front end-side part of the sensor element 20 is exposed to the measurement-object gas.

The protective cover 30 includes, as illustrated in FIG. 1, a hollow cylindrical inner protective cover 31 with a bottom which covers the front end-part of the sensor element 20 and a hollow cylindrical outer protective cover 32 with a bottom which covers the inner protective cover 31. Each of the inner and outer protective covers 31 and 32 has a plurality of holes formed therein, through which the measurement-object gas is passed. The space surrounded by the inner protective cover 31 serves as an element chamber 33. A fifth surface 60e (front end-side surface) of the sensor element 20 is located inside the element chamber 33.

The element-sealing member 40 is a member with which the sensor element 20 is sealed and fixed. The element-sealing member 40 includes a cylindrical body 41 including a main fitting 42 and an inner cylinder 43, insulators 44a to 44c, compacts 45a and 45b, and a metal ring 46. The sensor element 20 is located on the central axis of the element-sealing member 40 and penetrates the element-sealing member 40 in the top-to-bottom direction.

The main fitting 42 is a hollow cylindrical member made of a metal. The front-side part of the main fitting 42 is a thick-wall portion 42a having a smaller inside diameter than the rear-side part of the main fitting 42. The protective cover 30 is attached to a part of the main fitting 42 which is on the same side as the front end-side of the sensor element 20 (front-side part of the main fitting 42). The rear end of the main fitting 42 is welded to a flange portion 43a of the inner cylinder 43. A part of the inner peripheral surface of the thick-wall portion 42a serves as a bottom surface 42b, which is a stepped surface. The bottom surface 42b holds the insulator 44a such that the insulator 44a does not protrude forward.

The inner cylinder 43 is a hollow cylindrical member made of a metal and includes the flange portion 43a formed at the front end of the inner cylinder 43. The inner cylinder 43 and the main fitting 42 are coaxially fixed to each other by welding. The inner cylinder 43 includes a diameter reduction portion 43c that presses the compact 45b toward the central axis of the inner cylinder 43 and a diameter reduction portion 43d that presses the insulators 44a to 44c and the compacts 45a and 45b in the downward direction in FIG. 1 with the metal ring 46 interposed therebetween, the diameter reduction portions 43c and 43d being formed in the inner cylinder 43.

The insulators 44a to 44c and the compacts 45a and are interposed between the inner peripheral surface of the cylindrical body 41 and the sensor element 20. The insulators 44a to 44c serve as a support for the compacts and 45b. Examples of the material for the insulators 44a to 44c include ceramics, such as alumina, steatite, zirconia, spinel, cordierite, and mullite, and glass. The compacts 45a and 45b are formed by, for example, molding a powder and serve as a sealing medium. Examples of the material for the compacts 45a and 45b include talc and ceramic powders, such as an alumina powder and boron nitride. The compacts 45a and 45b may include at least one of the above materials. The compact 45a is filled between the insulators 44a and 44b and pressed by the insulators 44a and 44b as a result of both (front and rear) ends of the compact 45a in the axial direction being sandwiched therebetween. The compact 45b is filled between the insulators 44b and 44c and pressed by the insulators 44b and 44c as a result of both (front and rear) ends of the compact 45b in the axial direction being sandwiched therebetween. The insulators 44a to 44c and the compacts 45a and 45b are sandwiched between the diameter reduction portion 43d and the metal ring 46, and the bottom surface 42b of the thick-wall portion 42a of the main fitting 42 and thereby pressed in the front-to-rear direction. As a result of the compacts 45a and 45b being compressed between the cylindrical body 41 and the sensor element 20 by the pressing force applied by the diameter reduction portions 43c and 43d, the compacts 45a and 45b seal the communication between the element chamber 33 formed inside the protective cover 30 and a space 49 created inside the external cylinder 48 and fix the sensor element 20.

The bolt 47 is fixed to the outer surface of the main fitting 42 coaxially with the main fitting 42. The bolt 47 includes a male thread portion formed in the outer peripheral surface of the bolt 47. The male thread portion is inserted into a fixing member 59, which is welded to the pipe 58 and includes a female thread portion formed in the inner peripheral surface of the fixing member 59. This enables the gas sensor 10 to be fixed to the pipe 58 while the front end-side part of the sensor element 20 of the gas sensor 10 and the protective cover 30 of the gas sensor 10 are protruded toward the inside of the pipe 58.

The external cylinder 48 is a hollow cylindrical member made of a metal and covers the inner cylinder 43, the rear end-side part of the sensor element 20, and the connector 50. The upper part of the main fitting 42 is inserted into the external cylinder 48. The lower end of the external cylinder 48 is welded to the main fitting 42. A plurality of the lead wires 55, which are connected to the connector 50, are drawn from the upper end of the external cylinder 48 to the outside. The connector 50 is in contact with upper and lower connector electrodes 71 and 72 disposed on the rear end-side parts of the surfaces of the sensor element 20 and electrically connected to the sensor element 20. The lead wires 55 are in electrical conduction with electrodes 64 to 68 and a heater 69 disposed inside the sensor element 20 via the connector 50. The gap between the external cylinder 48 and the lead wires 55 is sealed with the rubber stopper 57. The space 49 inside the external cylinder 48 is filled with a reference gas. A sixth surface (rear end-side surface) of the sensor element 20 is located inside the space 49.

The sensor element 20 includes an element main body 60, a detection unit 63, a heater 69, an upper connector electrode 71, a lower connector electrode 72, a porous layer 80, and a water-penetration reduction portion 90 as illustrated in FIGS. 2 to 5. The element main body 60 includes a multilayer body constituted by a plurality of (6 layers in FIG. 3) oxygen ion-conducting solid-electrolyte layers composed of zirconia (ZrO₂) or the like which are stacked on top of one another. The element main body 60 has a long-length, rectangular cuboid shape, and the longitudinal direction of the element main body 60 is parallel to the front-to-rear direction. The element main body 60 has first to sixth surfaces 60a to 60f, which are the upper, lower, left, right, front, and rear outer surfaces of the element main body 60. The first to fourth surfaces 60a to 60d are surfaces that extend in the longitudinal direction of the element main body 60 and correspond to the side surfaces of the element main body 60. The fifth surface 60e is the front end-side surface of the element main body 60. The sixth surface 60f is the rear end-side surface of the element main body 60. The dimensions of the element main body 60 may be, for example, 25 mm or more and 100 mm or less long, 2 mm or more and 10 mm or less wide, and 0.5 mm or more and 5 mm or less thick. The element main body 60 includes a gas-to-be-analyzed introduction port 61 formed in the fifth surface 60e, through which the measurement-object gas is introduced into the element main body 60, and a reference gas introduction port 62 formed in the sixth surface 60f, through which a reference gas (in this embodiment, air) used as a reference for detecting the particular gas concentration is introduced into the element main body 60.

The detection unit 63 detects the specific gas concentration in the measurement-object gas. The detection unit 63 includes a plurality of electrodes disposed in the front end-side part of the element main body 60. In this embodiment, the detection unit 63 includes an outer electrode 64 disposed on the first surface 60a and an inner main pump electrode 65, an inner auxiliary pump electrode 66, a measurement electrode 67, and a reference electrode 68 that are disposed inside the element main body 60. The inner main pump electrode 65 and the inner auxiliary pump electrode 66 are disposed on the inner peripheral surface of a cavity formed inside the element main body 60 and have a tunnel-like structure.

Since the principle on which the detection unit 63 detects the specific gas concentration in the measurement-object gas is publicly known, detailed description is omitted herein. The detection unit 63 detects the particular gas concentration, for example, in the following manner. The detection unit 63 draws oxygen included in the measurement-object gas which is in the vicinity of the inner main pump electrode 65 to or from the outside (the element chamber 33) on the basis of the voltage applied between the outer electrode 64 and the inner main pump electrode 65. The detection unit 63 also draws oxygen included in the measurement-object gas which is in the vicinity of the inner auxiliary pump electrode 66 to or from the outside (the element chamber 33) on the basis of the voltage applied between the outer electrode 64 and the inner auxiliary pump electrode 66. This enables the measurement-object gas to reach a space around the measurement electrode 67 after the oxygen concentration in the gas has been adjusted to be a predetermined value. The measurement electrode 67 serves as a NOx-reducing catalyst and reduces the particular gas (NOx) included in the measurement-object gas. The detection unit 63 converts an electromotive force generated between the measurement electrode 67 and the reference electrode 68 in accordance with the oxygen concentration in the reduced gas or a current that flows between the measurement electrode 67 and the outer electrode 64 on the basis of the electromotive force into an electrical signal. The electrical signal generated by the detection unit 63 indicates the value reflective of the particular gas concentration in the measurement-object gas (the value from which the particular gas concentration can be derived) and corresponds to the value detected by the detection unit 63.

The heater 69 is an electric resistor disposed inside the element main body 60. Upon the heater 69 being fed with power from the outside, the heater 69 generates heat and heats the element main body 60. The heater 69 is capable of heating the solid-electrolyte layers constituting the element main body 60 and conserving the heat such that the temperature is adjusted to be the temperature (e.g., 800° C.) at which the solid-electrolyte layers become active.

The upper connector electrode 71 and the lower connector electrode 72 are each disposed on the rear end-side part of any of the side surfaces of the element main body 60. The upper connector electrode 71 and the lower connector electrode 72 are electrodes that enable electrical conduction between the element main body 60 and the outside. The upper and lower connector electrodes 71 and 72 are not covered with the porous layer 80 and exposed to the outside. In this embodiment, four upper connector electrodes 71a to 71d, which serve as an upper connector electrode 71, are arranged in the left-to-right direction and disposed on the rear end-side part of the first surface 60a, and four lower connector electrodes 72a to 72d, which serve as a lower connector electrode 72, are arranged in the left-to-right direction and disposed on the rear end-side part of the second surface 60b (lower surface), which is opposite to the first surface 60a (upper surface). Each of the connector electrodes 71a to 71d and 72a to 72d is in electrical conduction with any of the electrodes 64 to 68 and the heater 69 included in the detection unit 63. In this embodiment, the upper connector electrode 71a is in conduction with the measurement electrode 67; the upper connector electrode 71b is in conduction with the outer electrode 64; the upper connector electrode 71c is in conduction with the inner auxiliary pump electrode 66; the upper connector electrode 71d is in conduction with the inner main pump electrode 65; the lower connector electrodes 72a to 72c are each in conduction with the heater 69; and the lower connector electrode 72d is in conduction with the reference electrode 68. The upper connector electrode 71b and the outer electrode 64 are in conduction with each other via an outer lead wire 75 disposed on the first surface 60a (see FIGS. 3 and 4). Each of the other connector electrodes is in conduction with a corresponding one of the electrodes and the heater 69 via a lead wire, through-hole, or the like formed inside the element main body 60.

The outer lead wire 75 is a conductive material including a noble metal, such as platinum (Pt), or a high-melting point metal, such as tungsten (W) or molybdenum (Mo). The outer lead wire 75 is preferably a cermet conductive material that includes the noble metal or high-melting point metal and the oxygen-ion-conductive solid electrolyte (in this embodiment, zirconia) included in the element body 60. In this embodiment, the outer lead wire 75 is a cermet conductive material that includes platinum and zirconia. The porosity of the outer lead wire 75 may be, for example, 5% or more and 40% or less. The line width (thickness, i.e., width in the left-to-right direction) of the outer lead wire 75 is, for example, 0.1 mm or more and 1.0 mm or less. An insulating layer, which is not illustrated in the drawings, may be interposed between the outer lead wire 75 and the first surface 60a of the element body 60 in order to provide electrical insulation between the outer lead wire 75 and the solid electrolyte layer of the element body 60.

The porous layer 80 is a porous body that covers at least the front end-side parts of the side surfaces of the element main body 60 on which the upper and lower connector electrodes 71 and 72 are disposed, that is, the first and second surfaces 60a and 60b. In this embodiment, the porous layer 80 includes an inner porous layer 81 that covers the first and second surfaces 60a and 60b and an outer porous layer 85 disposed on the outer surface of the inner porous layer 81.

The inner porous layer 81 includes a first inner porous layer 83 that covers the first surface 60a and a second inner porous layer 84 that covers the second surface 60b. The first inner porous layer 83 covers the entirety of the region extending from the front end to the rear end of the first surface 60a on which the upper connector electrodes 71a to 71d are disposed, except the regions in which a first water-penetration reduction portion 91 and the upper connector electrode 71 are present (see FIGS. 2 to 4). The width of the first inner porous layer 83 in the left-to-right direction is equal to the width of the first surface 60a in the left-to-right direction. The first inner porous layer 83 covers the region that extends from the left end to the right end of the first surface 60a. The first water-penetration reduction portion 91 divides the first inner porous layer 83 into a front end-side portion 83a located on the front end-side across the first water-penetration reduction portion 91 and a rear end-side portion 83b located on the rear end-side across the first water-penetration reduction portion 91 in the longitudinal direction. The first inner porous layer 83 covers at least a part of the outer electrode 64 and at least a part of the outer lead wire 75. In this embodiment, the first inner porous layer 83 covers the entirety of the outer electrode 64 and the entirety of the part of the outer lead wire 75 on which the first water-penetration reduction portion 91 is not present as illustrated in FIGS. 3 and 4. The first inner porous layer 83 serves as, for example, a protection layer that protects the outer electrode 64 and the outer lead wire 75 from the components of the measurement-object gas, such as sulfuric acid, and suppresses the corrosion and the like of the outer electrode 64 and the outer lead wire 75.

The second inner porous layer 84 covers the entirety of the region extending from the front end to the rear end of the second surface 60b on which the lower connector electrodes 72a to 72d are disposed, except the regions in which a second water-penetration reduction portion 94 and the lower connector electrode 72 are present (see FIGS. 2, 3, and 5). The width of the second inner porous layer 84 in the left-to-right direction is equal to the width of the second surface 60b in the left-to-right direction. The second inner porous layer 84 covers the region that extends from the left end to the right end of the second surface 60b. The second water-penetration reduction portion 94 divides the second inner porous layer 84 into a front end-side portion 84a located on the front end-side across the second water-penetration reduction portion 94 and a rear end-side portion 84b located on the rear end-side across the second water-penetration reduction portion 94 in the longitudinal direction.

The outer porous layer 85 covers the first to fifth surfaces 60a to 60e. The outer porous layer 85 covers the first surface 60a and the second surface 60b as a result of covering the inner porous layer 81. The length of the outer porous layer 85 in the front-to-rear direction is smaller than the length of the inner porous layer 81 in the front-to-rear direction. The outer porous layer 85 covers only the front end of the element main body 60 and a region of the element main body 60 around the front end, unlike the inner porous layer 81. Thus, the outer porous layer 85 covers a part of the element main body 60 which surrounds the electrodes 64 to 68 included in the detection unit 63. In other words, the outer porous layer 85 covers a part of the element main body 60 which is disposed inside the element chamber 33 and exposed to the measurement-object gas. Thereby, the outer porous layer 85 serves as, for example, a protection layer that reduces the likelihood of moisture and the like included in the measurement-object gas adhering to the element main body 60 and causing cracking of the element main body 60.

The porous layer 80 is composed of, for example, a ceramic porous body, such as an alumina porous body, a zirconia porous body, a spinel porous body, a cordierite porous body, a titania porous body, or a magnesia porous body. In this embodiment, the porous layer 80 is composed of an alumina porous body. The thicknesses of the first and second inner porous layers 83 and 84 may be, for example, 5 μm or more or 14 μm or more. The thicknesses of the first and second inner porous layers 83 and 84 may be 40 μm or less or 23 μm or less. The thickness of the outer porous layer 85 may be, for example, 40 μm or more and 800 μm or less. The porosity of the porous layer 80 is 10% or more. Although the porous layer 80 covers the outer electrode 64 and the measurement-object gas introduction port 61, the measurement-object gas can pass through the porous layer 80 when the porosity of the porous layer 80 is 10% or more. The porosity of the inner porous layer 81 may be 10% or more and 50% or less. The porosity of the outer porous layer 85 may be 10% or more and 85% or less. The outer porous layer may have a higher porosity than the inner porous layer 81.

The porosity of the inner porous layer 81 is determined by the following method using an image (SEM image) obtained by inspecting the inner porous layer 81 with a scanning electron microscope (SEM). First, the sensor element 20 is cut in the thickness direction of the inner porous layer 81 such that a cross section of the inner porous layer 81 can be inspected. The cross section is buried in a resin and ground in order to prepare an observation sample. An image of the observation cross section of the observation sample is taken with a SEM at a 1000 to 10000-fold magnification in order to obtain an SEM image of the inner porous layer 81. Subsequently, the image is subjected to image analysis. A threshold value is determined on the basis of the brightness distribution included in brightness data of pixels of the image by a discriminant analysis method (Otsu's binarization). On the basis of the threshold value, the pixels of the image are binarized into an object portion and a pore portion. The areas of the object portions and the pore portions are calculated. The ratio of the area of the pore portions to the total area (the total area of the object portions and the pore portions) is calculated as a porosity (unit: %). The porosity of the outer porous layer 85 and the porosities of the first and second dense layers 92 and 95, which are described below, are also calculated by the same method as described above.

The water-penetration reduction portion 90 reduces the capillarity of water through the element main body 60 in the longitudinal direction. In this embodiment, the water-penetration reduction portion 90 includes a first water-penetration reduction portion 91 and a second water-penetration reduction portion 94. The first water-penetration reduction portion 91 is disposed on the first surface 60a, on which the upper connector electrode 71 and the first inner porous layer 83 are disposed. As described above, the first water-penetration reduction portion 91 is disposed on the first surface 60a so as to divide the first inner porous layer 83 into front and rear parts in the longitudinal direction. The first water-penetration reduction portion 91 is arranged closer to the front end of the element main body 60 than the upper connector electrode 71, that is, disposed forward of the upper connector electrode 71. The first water-penetration reduction portion 91 is disposed backward of the outer electrode 64. The first water-penetration reduction portion 91 is disposed backward of any of the electrodes 64 to 68 included in the detection unit 63, in addition to the outer electrode 64 (see FIG. 3). The first water-penetration reduction portion 91 is arranged to overlap the insulator 44b in the front-to-rear direction (see FIG. 1). In other words, the region that extends from the front end to the rear end of the first water-penetration reduction portion 91 is included in the region that extends from the front end to the rear end of the insulator 44b. The first water-penetration reduction portion 91 blocks moisture that moves backward inside the front end-side portion 83a by capillarity from passing through the first water-penetration reduction portion 91 and reduces the likelihood of the moisture reaching the upper connector electrode 71. The first water-penetration reduction portion 91 includes a first dense layer 92 and a first gap region 93. The first dense layer 92 is a dense layer having a porosity of less than 10%. The width of the first dense layer 92 in the left-to-right direction is equal to the width of the first surface 60a in the left-to-right direction. The first dense layer 92 covers the first surface 60a so as to extend from the left end to the right end of the first surface 60a. The first dense layer 92 is adjacent to the rear end of the front end-side portion 83a. The first dense layer 92 covers a part of the outer lead wire 75 as illustrated in FIG. 4. The first gap region 93 is a region of the first surface 60a in which the porous layer 80 and the first dense layer 92 are not present. The first gap region 93 is a region between the rear end of the first dense layer 92 and the front end of the rear end-side portion 83b. The outer lead wire 75 is exposed to the outside at a part in which the first gap region 93 is present.

The second water-penetration reduction portion 94 is disposed on the second surface 60b, on which the lower connector electrode 72 and the second inner porous layer 84 are disposed. As described above, the second water-penetration reduction portion 94 is disposed on the second surface 60b so as to divide the second inner porous layer 84 into front and rear parts in the longitudinal direction. The second water-penetration reduction portion 94 is arranged closer to the front end of the element main body 60 than the lower connector electrode 72, that is, disposed forward of the lower connector electrode 72. The second water-penetration reduction portion 94 is disposed backward of the outer electrode 64. The second water-penetration reduction portion 94 is disposed backward of any of the electrodes 64 to 68 included in the detection unit 63, in addition to the outer electrode 64 (see FIG. 3). The second water-penetration reduction portion 94 is arranged to overlap the insulator 44b in the front-to-rear direction (see FIG. 1). In other words, the region that extends from the front end to the rear end of the second water-penetration reduction portion 94 is included in the region that extends from the front end to the rear end of the insulator 44b. The second water-penetration reduction portion 94 blocks moisture that moves backward inside the front end-side portion 84a by capillarity from passing through the second water-penetration reduction portion 94 and reduces the likelihood of the moisture reaching the lower connector electrode 72. The second water-penetration reduction portion 94 includes a second dense layer 95 and a second gap region 96. The second dense layer 95 is a dense layer having a porosity of less than 10%. The width of the second dense layer 95 in the left-to-right direction is equal to the width of the second surface 60b in the left-to-right direction. The second dense layer 95 covers the second surface 60b so as to extend from the left end to the right end of the second surface 60b. The second dense layer 95 is adjacent to the rear end of the front end-side portion 84a. The second gap region 96 is a region of the second surface 60b in which the porous layer 80 and the second dense layer 95 are not present. The second gap region 96 is a region between the rear end of the second dense layer 95 and the front end of the rear end-side portion 84b.

The length L of the first and second water-penetration reduction portions 91 and 94 in the longitudinal direction (see FIGS. 4 and 5) is preferably 0.5 mm or more. When the length L is 0.5 mm or more, the likelihood of the moisture passing through the first and second water-penetration reduction portions 91 and 94 can be reduced to a sufficient degree. The length L may be 5 mm or more. The length L may be 25 mm or less or 20 mm or less. Although the first and second water-penetration reduction portions 91 and 94 have the same length L in this embodiment, they may have different lengths L.

The first and second dense layers 92 and 95 may be composed of any of the ceramics described above as examples of the material for the porous layer 80, although the first and second dense layers 92 and 95 are different from the porous layer 80 in that the porosity of the first and second dense layers 92 and 95 is less than 10%. In this embodiment, the first and second dense layers 92 and 95 are composed of an alumina ceramic. The porosity of the first and second dense layers 92 and 95 is preferably 8% or less and is more preferably 5% or less. The smaller the porosity of the first and second dense layers 92 and 95, the higher the degree of reduction in the capillarity of water in the longitudinal direction of the element body 60 which is achieved by the first and second dense layers 92 and 95.

The length Le of the first and second dense layers 92 and 95 in the longitudinal direction (see FIGS. 4 and 5) is preferably 0.5 mm or more. In such a case, the likelihood of the moisture passing through the first and second water-penetration reduction portions 91 and 94 in the longitudinal direction can be reduced to a sufficient degree by using only the first and second dense layers 92 and 95, respectively. The length Le may be 5 mm or more. The length Le may be 20 mm or less. Although the first and second dense layers 92 and 95 have the same length Le in this embodiment, they may have different lengths Le.

The length Lg of the first gap region 93 and the second gap region 96 in the longitudinal direction is preferably 1 mm or less. When the length Lg is relatively small, the area of the parts of the side surfaces (in this embodiment, the first and second surfaces 60a and 60b) of the element main body 60 which are exposed to the outside, that is, the parts of the side surfaces which are not covered with any of the porous layer 80, the first dense layer 92, and the second dense layer 95, can be reduced. In particular, in this embodiment, the outer lead wire 75 is disposed on the first surface 60a, and the outer lead wire 75 is disadvantageously exposed to the outside in the region in which the first gap region 93 is present. Setting the length Lg of the first gap region 93 to be small reduces the area of the part of the outer lead wire 75 which is not covered with any of the porous layer 80 and the first dense layer 92.

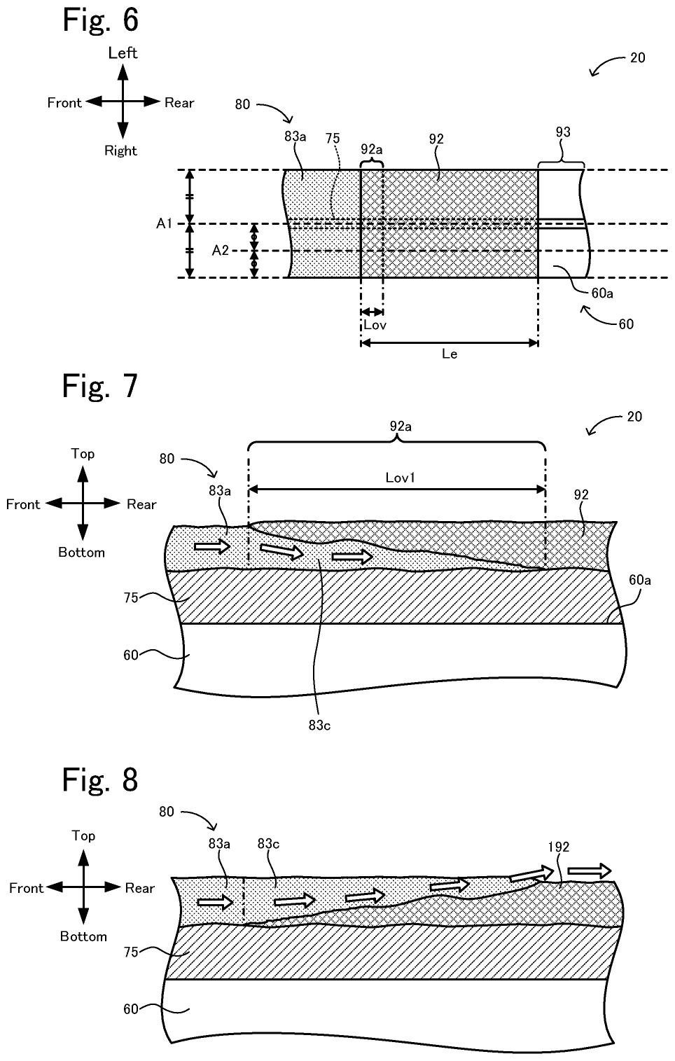

The first dense layer 92 includes an overlap portion 92a that is the front end portion of the first dense layer 92 and covers the outer surface of a part of the porous layer 80. FIG. 6 is a top view illustrating the positions of cross sections A1 and A2 in which the overlap length Lov is observed. FIG. 7 is a cross-sectional view illustrating the state of the overlap portion 92a of the first dense layer 92. As illustrated in FIGS. 6 and 7, the front end portion of the first dense layer 92 and a rear end portion 83c of the porous layer 80 overlaps each other in the top-to-bottom direction, and the front end portion of the first dense layer 92 is located at a position closer to the outside than (in this case, above) the rear end portion 83c. The front end portion of the first dense layer 92, that is, the portion that covers the outer surface of a part of the porous layer 80, is the overlap portion 92a. In this embodiment, the rear end portion 83c is the rear end portion of the front end-side portion 83a of the first inner porous layer 83 included in the porous layer 80. Since the first dense layer 92 includes the overlap portion 92a, the likelihood of the moisture that has moved backward through the front end-side portion 83a of the porous layer 80 by capillarity moving backward of the first dense layer 92 along the outer surface (in this case, the upper surface) of the first dense layer 92 can be reduced. In this embodiment, the overlap portion 92a is arranged to extend from the left to right ends of the first surface 60a of the element body 60 as illustrated in FIG. 6. As illustrated in FIG. 6, the overlap portion 92a according to this embodiment is substantially rectangular when viewed from top.

The length of the overlap portion 92a in the longitudinal direction (in this case, the front-to-rear direction) of the element body 60, that is, the overlap length Lov, may be 40 μm or more. The overlap length Lov may be 100 μm or more or 150 μm or more. The overlap length Lov may be 10000 μm (i.e., 10 mm) or less. The overlap length Lov may be less than 0.2 times the length Le of the first dense layer 92.

The overlap length Lov is the value measured using an image (SEM image) obtained by observation with a scanning electron microscope (SEM) by the following method. First, as illustrated in FIG. 6, a cross section A1 that divides the first dense layer 92 into left and right halves is determined with reference to left and right ends of the surface (in this case, the first surface 60a) of the element body 60 on which the first dense layer 92 is disposed. Then, a cross section A2 that divides the portion that extends from the cross section A1 to the right end of the first surface 60a into left and right halves is determined. The sensor element 20 is cut in the thickness direction of the first dense layer 92 such that the cross sections A1 and A2 can be observed. The cut sections (cross sections A1 and A2) are buried in a resin and ground to prepare observation samples. Images of the observation cross sections of the observation samples are taken with a SEM at a 200 to 500-fold magnification in order to obtain SEM images of the cross sections A1 and A2. FIG. 7 illustrates an example of the state of the cross section A1. As illustrated in FIG. 7, in this cross section, the porous layer 80 and the first dense layer 92 are present at a position closer to the outside than (in this case, above) the outer lead wire 75. Subsequently, a portion of the SEM image of the cross section A1 which is the periphery of the front end portion of the first dense layer 92 and the rear end portion 83c of the porous layer 80 is observed in order to measure the distance (length Lov1 in FIG. 7) from the front end of the overlap portion 92a (the front end portion of the first dense layer 92) to the rear end of the rear end portion 83c in the front-to-rear direction. In the same manner as described above, the distance (length Lov2, not illustrated in the drawings) from the front end of the overlap portion 92a to the rear end of the rear end portion 83c in the front-to-rear direction is measured on the basis of the SEM image of the cross section A2. While the outer lead wire 75 is absent in the cross section A2 unlike FIG. 7, Lov2 can be measured as in the measurement of Lov1. The average of the lengths Lov1 and Lov2 is defined as an overlap length Lov.

As described above, the overlap length Lov is determined on the basis of the lengths of the overlap portion 92a in the two cross sections (A1 and A2). It is preferable that the length of the overlap portion 92a in another cross section be substantially equal to the overlap length Lov. For example, even in the case where the overlap portion 92a is observed in any cross section parallel to the top-to-bottom or front-to-rear direction of the sensor element 20, the length of the overlap portion 92a in the cross section in the front-to-rear direction is preferably 0.6 times or more and 1.4 times or less and is more preferably 0.84 times or more and 1.16 times or less the overlap length Lov. In other words, it is preferable that the minimum length of the overlap portion 92a in the front-to-rear direction be 0.6 times or more the overlap length Lov and the maximum length of the overlap portion 92a in the front-to-rear direction be 1.4 times or less the overlap length Lov, and it is more preferable that the minimum length of the overlap portion 92a in the front-to-rear direction be 0.84 times or more the overlap length Lov and the maximum length of the overlap portion 92a in the front-to-rear direction be 1.16 times or less the overlap length Lov. In still other words, the quotient of the maximum length of the overlap portion 92a in the front-to-rear direction divided by the minimum length of the overlap portion 92a in the front-to-rear direction is preferably 2.33 times (=1.4/0.6) or less and is more preferably 1.38 times (=1.16/0.84) or less.

The method for producing the gas sensor 10 is described below. First, the method for producing the sensor element 20 is described. In the production of the sensor element 20, first, a plurality of (in this embodiment, six) unbaked ceramic green sheets that correspond to the element body 60 are prepared. In each of the green sheets, as needed, notches, through-holes, grooves, and the like are formed by punching or the like, and electrodes and wire patterns are formed by screen printing. The wire patterns include a pattern of an unbaked lead wire that is to be formed into an outer lead wire 75 after baking. In addition, unbaked porous layers that are to be formed into the first and second inner porous layers 83 and 84 after baking and unbaked dense layers that are to be formed into the first and second dense layers 92 and 95 after baking are formed on the surfaces of the green sheets which correspond to the first and second surfaces 60a and 60b by screen printing. Subsequently, the green sheets are stacked on top of one another. The green sheets stacked on top of one another are an unbaked element body that is to be formed into the element body after baking and include unbaked porous layers and unbaked dense layers. The unbaked element body is baked to form the element body 60 including the outer lead wire 75, the first inner porous layer 83, the second inner porous layer 84, the first dense layer 92, and the second dense layer 95. Subsequently, the outer porous layer 85 is formed by plasma spraying. Hereby, the sensor element 20 is prepared. For producing the porous layer 80, the first dense layer 92, and the second dense layer 95, gel casting, dipping, and the like can be used in addition to screen printing and plasma spraying. After the unbaked porous layer that is to be formed into a first inner porous layer 83 has been formed, the unbaked dense layer that is to be formed into a first dense layer 92 is formed so as to partially overlap the above unbaked porous layer in order to produce a first dense layer 92 including an overlap portion 92a. The overlap length Lov can be adjusted by changing the shapes of the unbaked porous layer and the unbaked dense layer and the positions at which the unbaked porous layer and the unbaked dense layer are formed.

The gas sensor 10 that includes the sensor element 20 is produced. First, the sensor element 20 is inserted into the cylindrical body 41 so as to penetrate the cylindrical body 41 in the axial direction. Subsequently, the insulator 44a, the compact 45a, the insulator 44b, the compact 45b, the insulator 44c, and the metal ring 46 are disposed in the gap between the inner peripheral surface of the cylindrical body 41 and the sensor element 20 in this order. Then, the metal ring 46 is pressed in order to compress the compacts 45a and 45b. While the compacts 45a and 45b are compressed, the diameter reduction portions 43c and 43d are formed. Hereby, the element-sealing member 40 is produced, and the gap between the inner peripheral surface of the cylindrical body 41 and the sensor element 20 is sealed. The protective cover 30 is welded to the element-sealing member 40, and the bolt 47 is attached to the element-sealing member 40. Hereby, the assembly 15 is produced. Lead wires 55 attached to a rubber stopper 57 so as to penetrate the rubber stopper 57 and a connector 50 connected to the lead wires 55 are prepared. The connector is connected to the rear end-side part of the sensor element 20. Subsequently, the external cylinder 48 is fixed to the main fitting 42 by welding. Hereby, the gas sensor is produced.

An example of the application of the gas sensor 10 is described below. When the measurement-object gas flows inside the pipe 58 while the gas sensor 10 is attached to the pipe 58 as illustrated in FIG. 1, the measurement-object gas passes through the inside of the protective cover 30 and enters the element chamber 33. Consequently, the front end-side part of the sensor element 20 is exposed to the measurement-object gas. Upon the measurement-object gas passing through the porous layer 80, reaching the outer electrode 64, and reaching the inside of the sensor element through the gas-to-be-analyzed introduction port 61, the detection unit 63 generates an electrical signal reflective of the NOx concentration in the measurement-object gas, as described above. The electrical signal is drawn through the upper and lower connector electrodes 71 and 72. The NOx concentration can be determined on the basis of the electrical signal.

The measurement-object gas may contain moisture, which may move inside the porous layer 80 by capillarity. If the moisture reaches the upper and lower connector electrodes 71 and 72, which are exposed to the outside, the water and the components dissolved in the water, such as sulfuric acid, may cause rusting and corrosion of the upper and lower connector electrodes 71 and 72 and a short circuit between some of the upper and lower connector electrodes 71 and 72 which are adjacent to one another. However, in this embodiment, even when the moisture contained in the measurement-object gas moves inside the porous layer 80 (in particular, inside the first and second inner porous layers 83 and 84) toward the rear end-side part of the element body 60 by capillarity, the moisture reaches the first water-penetration reduction portion 91 or the second water-penetration reduction portion 94 before reaching the upper and lower connector electrodes 71 and 72. The first water-penetration reduction portion 91 includes the first dense layer 92 having a porosity of less than 10% and the first gap region 93 that is a space in which the porous layer 80 is absent, and both of them reduce the capillarity of water in the longitudinal direction of the element body 60. By the above mechanisms, the first water-penetration reduction portion 91 reduces the likelihood of the moisture passing through the first water-penetration reduction portion 91 from the front end-side portion 83a-side and reaching the upper connector electrode 71 (the upper connector electrodes 71a to 71d). Therefore, in the sensor element 20, the above-described trouble caused by the water adhering to the upper connector electrode 71 may be reduced. In the similar manner as described above, the second water-penetration reduction portion 94, which includes the second dense layer 95 and the second gap region 96, reduces the likelihood of the moisture passing through the second water-penetration reduction portion 94 from the front end-side portion 84a-side and reaching the lower connector electrode 72 (the lower connector electrodes 72a to 72d). Therefore, in the sensor element 20, the above-described trouble caused by the water adhering to the lower connector electrode 72 may be reduced. The length L of the first water-penetration reduction portion 91 in the longitudinal direction is preferably 0.5 mm or more in order to reduce the likelihood of the moisture passing through the first water-penetration reduction portion 91 to a sufficient degree. Similarly, the length L of the second water-penetration reduction portion 94 is preferably 0.5 mm or more.

As described above, since the porosity of the first dense layer 92 is less than 10%, the moisture is unlikely to pass through the inside of the first dense layer 92. Moreover, in this embodiment, the first dense layer 92 includes the overlap portion 92a. Consequently, the moisture that has moved inside the porous layer 80 toward the rear end of the element body 60 moves into the rear end portion 83c of the front end-side portion 83a of the first inner porous layer 83, that is, a portion of the front end-side portion 83a which is below the overlap portion 92a, so as to sink below the overlap portion 92a (see the hollow arrows in FIG. 7). Since the upper surface of the rear end portion 83c is covered with the overlap portion 92a, the likelihood of the moisture that has reached the rear end portion 83c moving backward of the first dense layer 92 along the outer surface of the first dense layer 92 (in this case, the upper surface of the first dense layer 92) can be reduced. In contrast, for example, if the rear end portion 83c is located at a position closer to the outside than (in this case, above) a first dense layer 192 as in Comparative Example illustrated in FIG. 8, the moisture that has reached the rear end portion 83c may disadvantageously reach the outer surface of the first dense layer 192 (see the hollow arrows in FIG. 8). In such a case, although the moisture cannot pass through inside of the first dense layer 192, the moisture may disadvantageously move backward of the first dense layer 192 along the outer surface of the first dense layer 192 to reach the upper connector electrode 71. In the sensor element 20 according to this embodiment, since the first dense layer 92 includes the overlap portion 92a, the moisture is unlikely to pass through not only the inside but also the outer surface of the first dense layer 92. This reduces the likelihood of the moisture reaching the upper connector electrode 71. Although not illustrated in the drawings, in the case where the first dense layer 92 and the front end-side portion 83a of the first inner porous layer 83 are simply arranged adjacent to each other but do not overlap each other in the top-to-bottom direction at all, the moisture is likely to reach the outer surface of the first dense layer 92 compared with FIG. 7. Thus, even compared with the case where the first dense layer 92 and the first inner porous layer 83 are not arranged to overlap each other in the top-to-bottom direction at all, the presence of the overlap portion 92a reduces the likelihood of the moisture reaching the upper connector electrode 71.

The thickness of the first dense layer 92 may be, for example, 3 μm or more. The thickness of the first dense layer 92 may be, for example, 40 μm or less, 32 μm or less, 10 μm or less, 6 μm or less, 5 μm or less, or less than 5 μm. The thickness of the first dense layer 92 is the thickness of a portion of the first dense layer 92 which is other than the overlap portion 92a. The above numerical ranges also apply to the thickness of the second dense layer 95. The thickness of the second dense layer 95 may be equal to or different from that of the first dense layer 92.

The correspondences between the elements constituting this embodiment and the elements constituting the present invention are explicitly described below: the element body 60 in this embodiment corresponds to the element body in the present invention; the detection unit 63 corresponds to the detection unit; the upper connector electrodes 71a to 71d correspond to the connector electrodes; the first surface 60a corresponds to the side surface on which the connector electrodes are disposed; the porous layer 80 corresponds to the porous layer; the first dense layer 92 corresponds to the dense layer; the overlap portion 92a corresponds to the overlap portion; the outer lead wire 75 corresponds to the outer lead portion; and the outer electrode 64 corresponds to the outer electrode.

In the sensor element 20 according to this embodiment which is described in detail above, the first dense layer 92 having a porosity of less than 10% is disposed on the first surface 60a so as to divide the porous layer 80 in the longitudinal direction of the sensor element Therefore, even when the moisture included in a measurement-object gas moves inside the porous layer 80 toward the rear end of the element body 60 by capillarity, the moisture is unlikely to pass through the inside of the first dense layer 92 because the capillarity of water is unlikely to occur inside the first dense layer 92. Furthermore, since the first dense layer 92 includes the overlap portion 92a that is the front end portion of the first dense layer 92 and that covers the outer surface of the rear end portion 83c, which is a part of the porous layer 80, the likelihood of the water that has moved inside the porous layer 80 toward the rear end of the element body moving backward of the first dense layer 92 along the outer surface of the first dense layer 92 can also be reduced. As described above, in the sensor element 20 according to this embodiment, water is unlikely to pass through the inside and outer surface of the first dense layer 92. This reduces the likelihood of the moisture reaching the upper connector electrode 71.

The sensor element 20 further includes an outer lead wire 75 disposed on the first surface 60a, on which the upper connector electrode 71 is disposed, and that connects the outer electrode 64, which is one of the plurality of electrodes included in the detection unit 63, and the upper connector electrode 71b. The porous layer 80 and the first dense layer 92 cover the outer lead wire 75. For reducing the likelihood of the moisture moving along the outer surface of the first dense layer 92, for example, a gap region may be interposed between the front end-side portion 83a of the first inner porous layer 83 included in the porous layer 80 and the front end of the first dense layer 92, instead of forming the overlap portion 92a. However, if such a gap region is formed when the outer lead wire 75 is present, the outer lead wire 75 is disadvantageously exposed to the outside of the sensor element 20 at the gap region. If the outer lead wire 75 is exposed to the outside of the sensor element 20, for example, when a gas sensor 10 that includes the sensor element 20 is produced, the outer lead wire 75 may become worn. In contrast, forming the overlap portion 92a instead of the gap region reduces the exposure of the outer lead wire 75 and thereby protects the outer lead wire 75 while reducing the likelihood of the moisture reaching the upper connector electrode 71.

It is to be understand that the present invention is not limited to the above-described embodiment at all, but intended to include a variety of forms within the technical scope of the present invention.

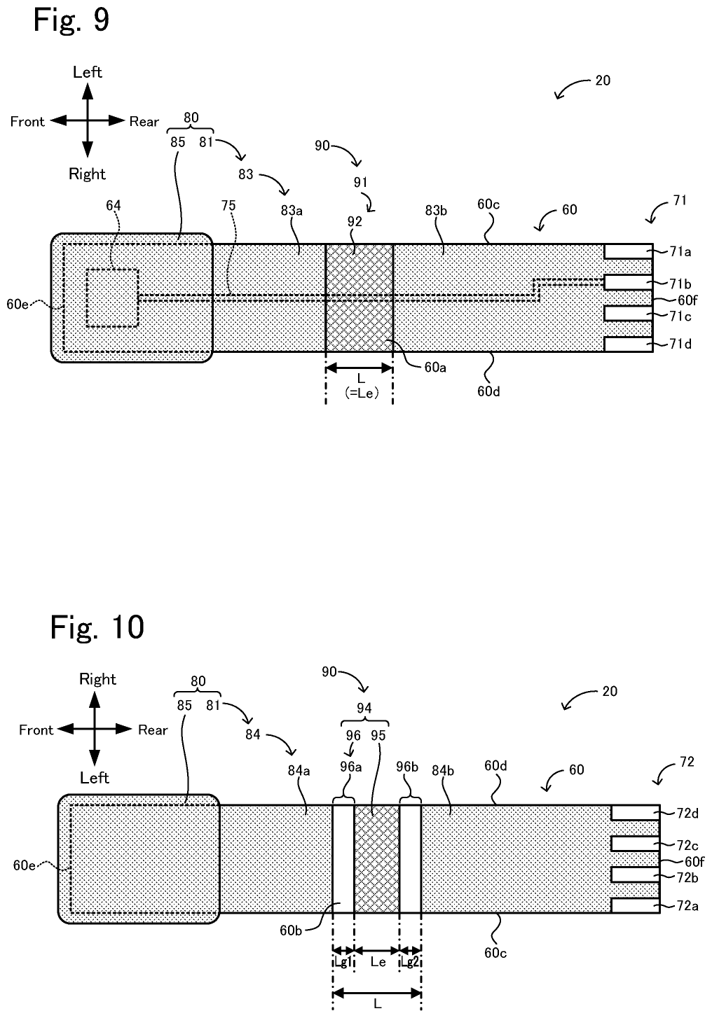

For example, although the first water-penetration reduction portion 91 includes the first dense layer 92 and the first gap region 93 in the above-described embodiment, the first water-penetration reduction portion 91 includes at least the first dense layer 92. That is, the first water-penetration reduction portion 91 does not necessarily include the first gap region 93. In other words, the length Lg in the first water-penetration reduction portion 91 may be 0 mm. FIG. 9 is a top view of such a sensor element 20. When the first water-penetration reduction portion 91 does not include the first gap region 93, the area of a part of the first surface 60a which is exposed to the outside (the portion that is not covered with any of the porous layer 80 and the first dense layer 92) can be further reduced. The same applies to the second water-penetration reduction portion 94. Moreover, in order to avoid the outer lead portion from being worn in the production of the gas sensor 10 and protect the outer lead portion as described above, it is preferable that a gap region, such as the first gap region 93, be not disposed on one of the side surfaces of the element body 60 on which the outer lead portion is disposed. For example, in the above-described embodiment, it is preferable that the first water-penetration reduction portion 91 do not include the first gap region 93 in order to protect the outer lead wire 75 since the outer lead wire 75 is disposed on the first surface 60a. On the other hand, in the above-described embodiment, the second water-penetration reduction portion 94 may include the second gap region 96 since an outer lead portion, such as the outer lead wire 75, is not disposed on the second surface 60b.

Although the first water-penetration reduction portion 91 divides the first inner porous layer 83 into the front end-side portion 83a and the rear end-side portion 83b in the longitudinal direction in the above-described embodiment, the present invention is not limited to this. The first water-penetration reduction portion 91 may be arranged closer to the rear end than the porous layer 80. For example, in the above-described embodiment, the first inner porous layer 83 does not necessarily include the rear end-side portion 83b. In such a case, the region in which the rear end-side portion 83b is disposed in FIG. 4 is considered a part of the first gap region 93. Similarly to the first water-penetration reduction portion 91, the second water-penetration reduction portion 94 may be arranged closer to the rear end than the porous layer 80 instead of dividing the second inner porous layer 84 into two parts.

Although the second dense layer 95 is disposed forward of the second gap region 96 so as to be adjacent to the second gap region 96 in the above-described embodiment, the second dense layer 95 may be disposed backward of the second gap region 96 so as to be adjacent to the second gap region 96. In another case, the second gap region 96 may be formed both forward and backward of the second dense layer 95 so as to be adjacent to the second dense layer 95. FIG. 10 illustrates an example case where the second gap region 96 is present both forward and backward of the second dense layer 95 so as to be adjacent to the second dense layer 95. The second gap region 96 illustrated in FIG. 10 includes a front gap region 96a disposed forward of the second dense layer 95 so as to be adjacent to the second dense layer 95 and a rear gap region 96b disposed backward of the second dense layer 95 so as to be adjacent to the second dense layer 95. Note that, in the case where the second gap region 96 is divided into a plurality of regions, such as the front gap region 96a and the rear gap region 96b illustrated in FIG. 10, the total of the lengths of the regions in the longitudinal direction is considered as the length Lg described above. Thus, in the example illustrated in FIG. 10, the total of the length Lg1 of the front gap region 96a in the longitudinal direction and the length Lg2 of the rear gap region 96b in the longitudinal direction is the length Lg, and the length Lg is preferably 1 mm or less as described above.

Although the first and second water-penetration reduction portions 91 and 94 are arranged to overlap the insulator 44b in the front-to-rear direction in the above-described embodiment, the present invention is not limited to this. For example, the first and second water-penetration reduction portions 91 and 94 may be arranged to overlap the insulator 44a or the insulator 44c in the front-to-rear direction or may be disposed backward of the metal ring 46. The first and second water-penetration reduction portions 91 and 94 are preferably disposed so as not to be exposed to the inside of the element chamber 33.

In the above-described embodiment, the sensor element 20 does not necessarily include the second inner porous layer 84 and the second surface 60b is not necessarily covered with the porous layer 80. In such a case, the sensor element 20 does not necessarily include the second water-penetration reduction portion 94. The water-penetration reduction portion may be disposed on at least one of the side surfaces of the element main body (in the above-described embodiment, the first to fourth surfaces 60a to 60d) on which the connector electrodes and the porous protection layer are disposed (in the above-described embodiment, the first or second surface 60a or 60b). This reduces the likelihood of the moisture reaching the connector electrodes at least on the side surface on which the water-penetration reduction portion is disposed.

Although the first inner porous layer 83 covers the region that extends from the front to rear ends of the first surface 60a except the region in which the first water-penetration reduction portion 91 and the upper connector electrode 71 are present in the above-described embodiment, the present invention is not limited to this. For example, the first inner porous layer 83 may cover a region that extends from the front end of the first surface 60a to the front end-side ends of the upper connector electrodes 71a to 71d except the region in which the first water-penetration reduction portion 91 is present. Alternatively, the first inner porous layer 83 may cover at least a region that extends from the front end of the first surface 60a to the rear of the first water-penetration reduction portion 91 except the region in which the first water-penetration reduction portion 91 is present. The same applies to the second inner porous layer 84.

Although the element main body 60 has a rectangular cuboid shape in the above-described embodiment, the present invention is not limited to this. For example, the element main body 60 may have a hollow cylindrical shape or a solid cylindrical shape. In such a case, the element main body 60 has one side surface.

In the above-described embodiment, the first dense layer 92 includes the overlap portion 92a. Similarly to this, the second dense layer 95 may include an overlap portion. Specifically, the second dense layer 95 may include an overlap portion that is the front end portion of the second dense layer 95 and that covers the outer surface (in this case, the bottom surface) of the rear end portion of the front end-side portion 84a of the second inner porous layer 84 that is a part of the porous layer 80.

Although the gas sensor 10 detects NOx concentration as a specific gas concentration in the above-described embodiment, the present invention is not limited to this. The concentration of another oxide may be detected as a specific gas concentration. In the case where the specific gas is an oxide, oxygen is generated when the specific gas is reduced in the vicinity of the measurement electrode 67 as in the above-described embodiment, and the concentration of the specific gas can be detected on the basis of the value detected by the detection unit 63 which corresponds to the oxygen. The specific gas may be a non-oxide, such as ammonia. In the case where the specific gas is a non-oxide, the specific gas is converted to an oxide in the vicinity of, for example, the inner main pump electrode 65 (e.g., ammonia is oxidized to NO) and oxygen is generated when the oxide is reduced in the vicinity of the measurement electrode 67. Thus, in such a case, the concentration of the specific gas can be detected on the basis of the value detected by the detection unit 63 which corresponds to the oxygen. As described above, regardless of whether the specific gas is an oxide or a non-oxide, the gas sensor 10 is capable of detecting the concentration of the specific gas on the basis of the oxygen that is derived from the specific gas and generated in the vicinity of the measurement electrode 67.

### EXAMPLES

Example cases where a specific sensor element was prepared are described below as Examples. Note that the present invention is not limited by Examples below.

### Example 1

In Example 1, a sensor element similar to the sensor elements 20 illustrated in FIGS. 2 to 5 was prepared, except that the first water-penetration reduction portion 91 did not include the first gap region 93 as illustrated in FIG. 9, the second water-penetration reduction portion 94 included the second dense layer 95 and the second gap region 96 (front gap region 96a and rear gap region 96b) as illustrated in FIG. 10, and the outer porous layer 85 was omitted. The sensor element 20 of Example 1 was prepared in the following manner. First, zirconia particles containing 4 mol % yttria serving as a stabilizer were mixed with an organic binder and an organic solvent. The resulting mixture was formed into six ceramic green sheets by tape casting. Patterns of the electrodes, the outer lead wire 75, and the like were printed in each of the green sheets. In addition, unbaked porous layers that were to be formed into the first and second inner porous layers 83 and 84 after baking were formed by screen printing. The pattern of an unbaked lead wire that was to be formed into an outer lead wire 75 after baking was formed using a slurry prepared by kneading platinum particles, zirconia particles, and a solvent with one another. The unbaked porous layers were composed of a slurry prepared by mixing a raw-material powder (an alumina powder), a binder solution (polyvinyl acetal and butyl carbitol), a solvent (acetone), and a pore-forming material with one another. The slurry for unbaked dense layers that were to be formed into first and second dense layers 92 and 95 after baking was prepared such that the first and second dense layers 92 and 95 had a porosity of 0%. Specifically, the slurry was the same as the slurry used for forming the unbaked porous layers, except that the pore-forming material was not added and the viscosity was adjusted by changing the amount of the solvent added. After the unbaked porous layer that was to be formed into a first inner porous layer 83 had been formed, the unbaked dense layer that was to be formed into a first dense layer 92 was formed so as to partially overlap the above unbaked porous layer. Subsequently, the six green sheets were stacked on top of one another and baked to prepare a sensor element 20 that included the outer lead wire 75, the first and second inner porous layers 83 and 84, and the first and second dense layers 92 and 95, the first dense layer 92 having the overlap portion 92a. Hereby, the sensor element 20 of Example 1 was prepared. The dimensions of the element body 60 were 67.5 mm long, 4.25 mm wide, and 1.45 mm thick. The first inner porous layer 83 had a thickness of 22.63 μm and a porosity of 30%. The length Le of the first dense layer 92 in the front-to-rear direction was 5 mm. Five sensor elements 20 of Example 1 were prepared. The overlap length Lov of one of the sensor elements measured by the above-described method was 156.9 μm. The overlap lengths Lov of the other four sensor elements were substantially equal to the above value.

### Comparative Example 1

In Comparative Example 1, a sensor element 20 was prepared as in Example 1, except that the first inner porous layer 83 and a first dense layer 192 were formed such that the rear end portion 83c was located at a position closer to the outside than the first dense layer 192 as illustrated in FIG. 8 and the overlap portion 92a was absent. In the preparation of the sensor element 20 of Comparative Example 1, the unbaked porous layers and the unbaked dense layers were formed in the reverse order of Example 1. Specifically, in Comparative Example 1, after the unbaked dense layer that was to be formed into a first dense layer 192 had been formed, the unbaked porous layer that was to be formed into a first inner porous layer 83 was formed so as to partially overlap the above unbaked dense layer. Although the positional relationship between the first dense layer 192 and the first inner porous layer 83 in the top-to-bottom direction was reverse of Example 1, the overlap length Lov was measured by the same method as described above. The overlap length Lov was 140.3 μm.

[Liquid Penetration Test]

The sensor elements 20 prepared in Example 1 and Comparative Example 1 were subjected to a liquid penetration test, in which whether the first dense layer was capable of blocking the penetration of a liquid into the rear end-side part of the element body 60 by capillarity when the front end-side part of the element body 60 was immersed in the liquid was determined. First, while the sensor element 20 was held such that the longitudinal direction of the sensor element 20 was parallel to the vertical direction, a part of the sensor element 20 which extended from the front end (fifth surface 60e) of the element body 60 to a position (hereinafter, “immersion position”) 25 mm from the front end toward the rear end was immersed into a red-check solution. While the sensor element was immersed in the red-check solution, the sensor element was left to stand for 24 hours. Subsequently, whether the red-check solution penetrated a region closer to the rear end than the first dense layer was visually determined. An evaluation of “Good” was given in the case where the red-check solution did not penetrate the above region, while an evaluation of “Poor” was given in the case where the red-check solution penetrated the above region. For each of Example 1 and Comparative Example 1, five sensor elements 20 were subjected to the liquid penetration test. In both of Example 1 and Comparative Example 1, the front end of the first dense layer was located at a position 26 mm from the front end of the element body 60. The red-check solution used was a stamp ink produced by Shachihata Inc. (for sol stamp stand) (Model No.: S-1, Color: Red). The red-check solution included water: 50 to 60 wt %, glycerin: 30 to 40 wt %, and dye: 5 to 15 wt %. The components and composition of the red-check solution are described in a safety data sheet (SDS) produced by Shachihata Inc.

Table 1 summarizes the positional relationship between the first dense layer and the first inner porous layer, the overlap length Lov, and the results of the liquid penetration test obtained in each of Example 1 and Comparative Example 1.

TABLE 1

| | | Comparative |
|---|---|---|
| | Example 1 | Example 1 |
| Layer Disposed | First Dense Layer | First Inner Porous Layer |
| on Outer Side | | |
| Layer Disposed | First Inner Porous Layer | First Dense Layer |
| on Inner Side | | |
| Overlap Length | 156.9 | 140.3 |
| Lov [μm] | | |
| Result of Liquid | 5/5 | 0/5 |
| Penetration Test | | |
| (Number of “Good”/ | | |
| Number of Test) | | |

As is understood from Table 1, in Example 1 where the first dense layer 92 included the overlap portion 92a, that is, the front end portion of the first dense layer 92 covered the outer surface of the rear end portion 83c of the first inner porous layer 83, all of the five sensor elements were evaluated as “Good” in the liquid penetration test. On the other hand, in Comparative Example 1 where the first dense layer 192 was located below the first inner porous layer 83, all of the five sensor elements were evaluated as “Poor” in the liquid penetration test. This confirms that, when the first dense layer 92 includes the overlap portion 92a, the likelihood of water moving backward of the first dense layer 92 toward the rear end can be reduced.

What is claimed is:

1. A sensor element comprising:
a long-length element body including front and rear ends and one or more side surfaces, the front and rear ends being ends of the element body in a longitudinal direction of the element body, the one or more side surfaces being surfaces extending in the longitudinal direction;
a detection unit including a plurality of electrodes disposed in the front end-side part of the element body, the detection unit detecting a specific gas concentration in a measurement-object gas;
one or more connector electrodes disposed on the rear end-side part of any of the one or more side surfaces, the one or more connector electrodes used for electrical conduction with an outside;
a porous layer that covers at least the front end-side part of the side surface on which the one or more connector electrodes are disposed, the porous layer having a porosity of 10% or more; and
a dense layer disposed on the side surface so as to divide the porous layer in the longitudinal direction or to be located closer to the rear end than the porous layer, the dense layer being located closer to the front end than the one or more connector electrodes, the dense layer covering the side surface and having a porosity of less than 10%,
wherein the dense layer includes an overlap portion that is a front end portion of the dense layer, the overlap portion covering an outer surface of a part of the porous layer.

2. The sensor element according to claim 1,
wherein an overlap length Lov that is a length of the overlap portion in the longitudinal direction is 40 μm or more.

3. The sensor element according to claim 1,
wherein an overlap length Lov that is a length of the overlap portion in the longitudinal direction is 10000 μm or less.

4. The sensor element according to claim 1,
the sensor element further comprising an outer lead portion disposed on the side surface on which the one or more connector electrodes are disposed, the outer lead portion providing electrical conduction between any of the electrodes and one of the one or more connector electrodes,
wherein the porous layer and the dense layer cover the outer lead portion.

5. The sensor element according to claim 2,
wherein an overlap length Lov that is a length of the overlap portion in the longitudinal direction is 10000 μm or less.

6. A gas sensor comprising the sensor element according to claim 1.
